(19) United States
(12) Patent Application Publication
(10) Pub. No.: US 2024/0080298 A1
(43) Pub. Date: Mar. 7, 2024

(54) TERMINAL DEVICE, NETWORK NODE, AND METHODS THEREIN FOR DERIVATION OF QoS RULE

(71) Applicant: Telefonaktiebolaget LM Ericsson (publ), Stockholm (SE)

(72) Inventors: Zongming ZHOU, Shanghai (CN); Ivo SEDLACEK, Hovorcovice (CZ)

(21) Appl. No.: 18/269,999

(22) PCT Filed: Dec. 23, 2021
(86) PCT No.: PCT/CN2021/140832

§ 371 Date: Jun. 28, 2023

(30) Foreign Application Priority Data
Dec. 31, 2020 (WO) PCT/CN2020/142025

(51) Int. Cl. H04L 9/40; H04L 47/24

(52) U.S. Cl. CPC H04L 63/0236; H04L 47/24; H04L 63/0485; H04L 2212/00

(57) ABSTRACT

The present disclosure provides a method in a terminal device. The method includes: receiving a downlink, DL, packet, the DL packet being Internet Protocol “IP” Security, IPSec, protected; and deriving a reflective Quality of Service, QoS, rule for uplink, UL, direction per IPSec Security Association, SA, based on the DL packet.

### TECHNICAL FIELD

The present disclosure relates to communication technology, and more particularly, to a terminal device, a network node, and methods therein for derivation of a Quality of Service (QoS) rule.

### BACKGROUND

According to the Internet Engineering Task Force (IETF) standard, an Internet Protocol (IP) Security (IPsec) protected packet can be encapsulated using Encapsulating Security Payload (ESP)/IP (IP encapsulation of IPsec ESP packet as defined in Request For Comments (RFC) 4304, which is incorporated herein by reference in its entirety) or ESP/User Datagram Protocol (UDP)/IP (UDP Encapsulation of IPsec ESP Packets as defined in RFC 3948, which is incorporated herein by reference in its entirety):
a) IP encapsulation of IPsec ESP packet (or referred to as ESP/IP Encapsulation): The IPsec protected packet is encapsulated using ESP/IP, as shown in an example on the right half of FIG. 1.
b) UDP encapsulation of IPsec ESP Packet (or referred to as ESP/UDP/IP Encapsulation): The IPsec protected packet is encapsulated using ESP/UDP/IP. As shown in an example on the left half of FIG. 1, it is identified by:
   Either the UDP source port and/or the UDP destination port number is 4500 (decimal)
   The data octets field is encoded in the UDP-encapsulated ESP header format as specified in IETF RFC 3948.

According to the IETF standard, an IPsec protected packet must be encapsulated using ESP/UDP/IP if there is a Network Address Translator (NATer) between an IPsec client (i.e., a User Equipment (UE)) and an IPsec server (i.e., an enterprise server). An IPsec protected packet can also be encapsulated using the ESP/UDP/IP even there is no NATer between the IPsec client and the IPsec server. In other words, if there is a NATer detected, only ESP/UDP/IP encapsulation is used; or if there is no NATer detected, which encapsulation is to be used depends on implementations.

According to the RFC 7296, which is incorporated herein by reference in its entirety, IPsec Security Associations (SAs) generally exist in pairs (uplink (UL) and downlink (DL)). There is an ESP Security Parameter Index (SPI) for each IPsec SA. ESP SPIs are used for matching between a pair of IPSec SAs. According to the RFC 4301, to secure typical, bi-directional communication between two IPsec-enabled systems, a pair of SAs (one in each direction) is required. However, for unidirectional communication, there may be no corresponding IPsec SA in the reverse direction.

For each pair of IPsec SAs, the IPsec SAs in the reverse direction may use the different encapsulations, as shown in Table 1 below.

TABLE 1
DL and UL Encapsulations

Encapsulation

| Option No. | DL | UL |
|---|---|---|
| 1 | ESP/UDP/IP | ESP/UDP/IP |
| 2 | ESP/UDP/IP | ESP/IP |
| 3 | ESP/IP | ESP/UDP/IP |
| 4 | ESP/IP | ESP/IP |

In the 5^{th} Generation (5G) system, a UE supports derivation of a reflective QoS rule based on a DL IP packet, such that a UL QoS rule can be generated or updated dynamically and quickly through the user plane. The derived QoS rule contains a QoS Flow Identifier (QFI), a packet filter for UL direction, and a precedence value of 80 (decimal).

FIG. 2 shows a procedure of a reflective QoS rule. As shown, at step 1, a User Plane Function (UPF) receives a DL packet destined to a UE and needs to generate or update a reflective QoS rule at a UE. The UPF sets a Reflective QoS Indicator (RQI) to 1 and, at step 2, transmits the DL packet, with a QFI and the RQI, to the UE via an Access Network (AN). At step 3, the UE checks the received DL packet, and if the RQI is set to 1 (yes in this case), the UE derives a reflective QoS rule (generates a new one or updates an existing one) based on the DL packet. In particular, the derived reflective QoS rule may contain a QFI set to the QFI in the DL packet, a packet filter for UL direction derived from the DL packet (referring to Section 5.7.5 of the 3^{rd} Generation Partnership Project (3GPP) Technical Specification (TS) 23.501, V16.7.0, which is incorporated herein by reference in its entirety), and a precedence value of 80 (decimal).

For IP Protocol Data Unit (PDU) Session Type, a packet filter set shall support packet filters based on at least any combination of:
Source/destination IP address or IP version 6 (IPv6) prefix,
Source/destination port number (no included in IPsec protected packets with ESP/IP encapsulation),
Protocol Identifier (ID) of the protocol above IP/Next header type,
Type of Service (TOS) (IP version 4 (IPv4))/Traffic Class (IPv6) and Mask,
Flow Label (IPv6),
SPI, or
Packet filter direction.

### SUMMARY

The 3GPP specifications, e.g., TS 23.501 and TS 24.501, V17.1.0, which is incorporated herein by reference in its entirety, only cover Option 4 in Table 1. For any of Options 1-3, the existing mechanism for derivation of reflective QoS rule does not work and thus it is not possible to apply differentiated QoS control to different IPSec SAs.

It is an object of the present disclosure to provide a terminal device, a network node, and methods therein for derivation of a reflective QoS rule.

According to a first aspect of the present disclosure, a method in a terminal device is provided. The method includes: receiving a DL packet, the DL packet being IPSec protected. The method further includes: deriving a reflective QoS rule for UL direction per IPSec SA based on the DL packet.

In an embodiment, the DL packet may have ESP/UDP/IP encapsulation or ESP/IP encapsulation.

In an embodiment, the operation of deriving the reflective QoS rule may include: when a UL IPsec SA corresponding to a DL IPSec SA associated with an SPI in the DL packet uses ESP/UDP/IP encapsulation: deriving a packet filter for UL IPSec protected packets with ESP/UDP/IP encapsulation based on an SPI associated with the UL IPSec SA.

In an embodiment, the method may further include: deriving a packet filter for UL IPSec protected packets with ESP/IP encapsulation based on an SPI associated with the UL IPSec SA.

In an embodiment, the operation of deriving the reflective QoS rule may include, when a UL IPsec SA corresponding to a DL IPSec SA associated with an SPI in the DL packet uses ESP/IP encapsulation: deriving a packet filter for UL IPSec protected packets with ESP/IP encapsulation based on an SPI associated with the UL IPSec SA.

In an embodiment, the method may further include: deriving a packet filter for UL IPSec protected packets with ESP/UDP/IP encapsulation based on an SPI associated with the UL IPSec SA.

In an embodiment, the packet filter for UL IPSec protected packets with ESP/UDP/IP encapsulation may contain an SPI type component set to the SPI associated with the UL IPSec SA.

In an embodiment, the packet filter for UL IPSec protected packets with ESP/UDP/IP encapsulation may further contain: a single local port type component set to a value of a source port field of the UL IPsec SA, and a single remote port type component set to a value of a destination port field of the UL IPsec SA.

In an embodiment, the packet filter for UL IPSec protected packets with ESP/UDP/IP encapsulation may further contain: an IP remote address component set to a value of a source address field of the DL packet, an IP local address component set to a value of a destination address field of the DL packet, and a protocol identifier or next header type component set to a value of UDP.

In an embodiment, when the DL packet has ESP/UDP/IP encapsulation, the packet filter for UL IPSec protected packets with ESP/UDP/IP encapsulation may further contain: a single local port type component set to a value of a destination port field of the DL packet, and a single remote port type component set to a value of a source port field of the DL packet.

In an embodiment, the packet filter for UL IPSec protected packets with ESP/UDP/IP encapsulation may further contain: an IP remote address component set to a value of a source address field of the DL packet, an IP local address component set to a value of a destination address field of the DL packet, and a protocol identifier or next header type component set to a value of a protocol identifier field or a last next header field of the DL packet.

In an embodiment, the packet filter for UL IPSec protected packets with ESP/IP encapsulation may contain an SPI type component set to the SPI associated with the UL IPSec SA.

In an embodiment, the packet filter for UL IPSec protected packets with ESP/IP encapsulation may further contain: an IP remote address component set to a value of a source address field of the DL packet, an IP local address component set to a value of a destination address field of the DL packet, and a protocol identifier or next header type component set to a value of ESP.

In an embodiment, when the DL packet has ESP/IP encapsulation, the packet filter for UL IPSec protected packets with ESP/IP encapsulation may further contain: an IP remote address component set to a value of a source address field of the DL packet, an IP local address component set to a value of a destination address field of the DL packet, and a protocol identifier or next header type component set to a value of a protocol identifier field or a last next header field of the DL packet.

In an embodiment, the DL packet may be an IPv4 packet having a protocol identifier set to UDP or ESP, or the DL packet may be an IPv6 packet having a last next header set to UDP or ESP.

In an embodiment, the DL packet may contain an RQI set to 1.

In an embodiment, the method may further include, for a UL packet that is IPSec protected and has ESP/UDP/IP encapsulation: when a reflective QoS rule for UL direction has IP header components matching IP header components of the UL packet and an SPI component matching an SPI component of the UL packet, associating the UL packet with the reflective QoS rule for UL direction, or when no reflective QoS rule for UL direction has IP header components matching the IP header components of the UL packet and an SPI component matching the SPI component of the UL packet, associating the UL packet with a reflective QoS rule for UL direction that has IP header components matching the IP header components of the UL packet and has no SPI component.

In an embodiment, the method may further include, for a UL packet that is Internet Key Exchange (IKE) protected and has ESP/UDP/IP encapsulation: associating the UL packet with a reflective QoS rule for UL direction that has IP header components matching IP header components of the UL packet and has no SPI component.

According to a second aspect of the present disclosure, a terminal device is provided. The terminal device includes a communication interface, a processor and a memory. The memory contains instructions executable by the processor whereby the terminal device is operative to perform the method according to the above first aspect.

According to a third aspect of the present disclosure, a computer readable storage medium is provided. The computer readable storage medium has computer program instructions stored thereon. The computer program instructions, when executed by a processor in a terminal device, cause the terminal device to perform the method according to the above first aspect.

According to a fourth aspect of the present disclosure, a method in a network node is provided. The method includes: receiving a DL packet destined to a terminal device, the DL packet being IPSec protected and having ESP/UDP/IP encapsulation. The method further includes: activating derivation of a reflective QoS rule for UL direction per IPSec SA based on the DL packet at the terminal device.

In an embodiment, the DL packet may be an IPv4 packet having a protocol identifier set to UDP, or the DL packet may be an IPv6 packet having a last next header set to UDP.

In an embodiment, the derivation may include derivation of a packet filter based on an SPI associated with a UL IPsec SA corresponding to a DL IPSec SA associated with an SPI in the DL packet.

In an embodiment, the operation of activating may include setting an RQI in the DL packet to 1.

In an embodiment, the network node may implement a UPF.

According to a fifth aspect of the present disclosure, a network node is provided. The network node includes a communication interface, a processor and a memory. The memory contains instructions executable by the processor whereby the network node is operative to perform the method according to the above fourth aspect.

According to a sixth aspect of the present disclosure, a computer readable storage medium is provided. The computer readable storage medium has computer program instructions stored thereon. The computer program instructions, when executed by a processor in a network node, cause the network node to perform the method according to the above fourth aspect.

With the embodiments of the present disclosure, upon receiving a DL packet that is IPSec protected, a reflective QoS rule for UL direction can be derived per IPSec SA based on the DL packet, which allows applying differentiated QoS control to different IPSec SAs, regardless of which encapsulation option is used for DL/UL.

### BRIEF DESCRIPTION OF THE DRAWINGS

The above and other objects, features and advantages will be more apparent from the following description of embodiments with reference to the figures, in which:

FIG. 1 is a schematic diagram showing exemplary formats of ESP/UDP/IP encapsulation and ESP/IP encapsulation, respectively;

FIG. 2 is a schematic diagram showing a procedure of reflective QoS rule;

FIG. 3 is a flowchart illustrating a method in a terminal device according to an embodiment of the present disclosure;

FIG. 4 is a flowchart illustrating a process of derivation of a packet filter for UL direction according to an embodiment of the present disclosure;

FIG. 5 is a flowchart illustrating a method in a network node according to an embodiment of the present disclosure;

FIG. 6 is a block diagram of a terminal device according to an embodiment of the present disclosure;

FIG. 7 is a block diagram of a terminal device according to another embodiment of the present disclosure;

FIG. 8 is a block diagram of a network node according to an embodiment of the present disclosure; and

FIG. 9 is a block diagram of a network node according to another embodiment of the present disclosure.

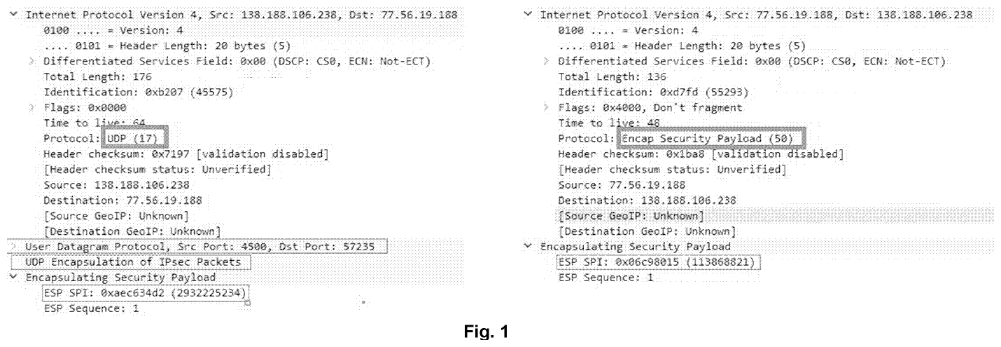

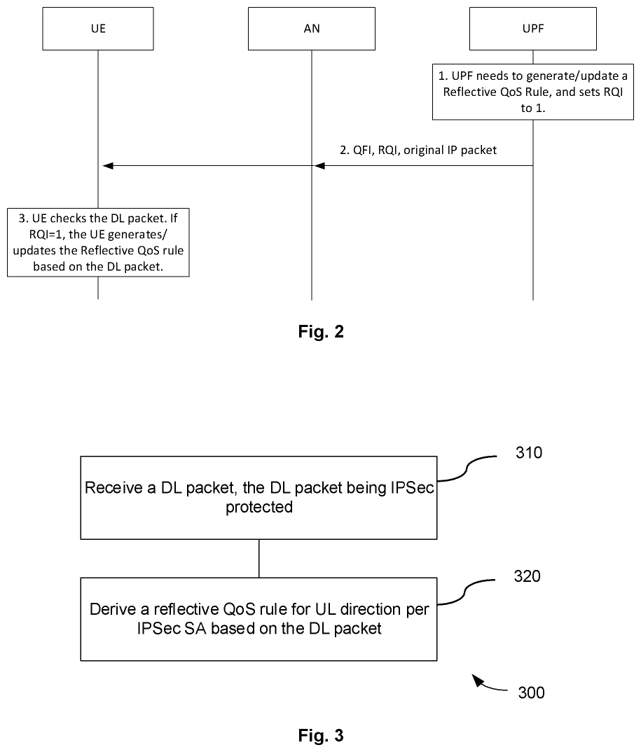

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network node in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

In the present disclosure, a network function, or NF, can be implemented either as a network element on a dedicated hardware, as a software instance running on a dedicated hardware, or as a virtualized function instantiated on an appropriate platform, e.g. on a cloud infrastructure. The term “network node” refers to any physical or virtual node configured to implement a network function.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a DL transmission refers to a transmission from the network node to a terminal device, and a UL transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

FIG. 3 is a flowchart illustrating a method 300 according to an embodiment of the present disclosure. The method 300 can be performed by a terminal device, e.g., a UE.

At block 310, a DL packet (e.g., a DL user data packet), which is IPSec protected, is received. The IPSec protected DL packet has a protocol identifier field or a last next header field indicating ESP, or has a protocol identifier field or a last next header field indicating UDP and satisfies the following two conditions:
Either the UDP source port and/or the UDP destination port number is 4500 (decimal)
The data octets field is encoded in the UDP-encapsulated ESP header format as specified in IETF RFC 3948.

Here, the DL packet has ESP/UDP/IP encapsulation or ESP/IP encapsulation. In an example, the DL packet may be an IPv4 packet having a protocol identifier set to UDP or ESP. In another example, the DL packet may be an IPv6 packet having a last next header set to UDP or ESP. The DL packet may contain an RQI set to 1.

At block 320, a reflective QoS rule for UL direction is derived per IPSec SA based on the DL packet. Here, as described above, the reflective QoS rule may contain a QFI set to a QFI in the DL packet, a packet filter for UL direction, and a precedence value of 80 (decimal). The derived reflective QoS rule can be a newly generated reflective QoS rule, or can be used to update an existing reflective QoS rule.

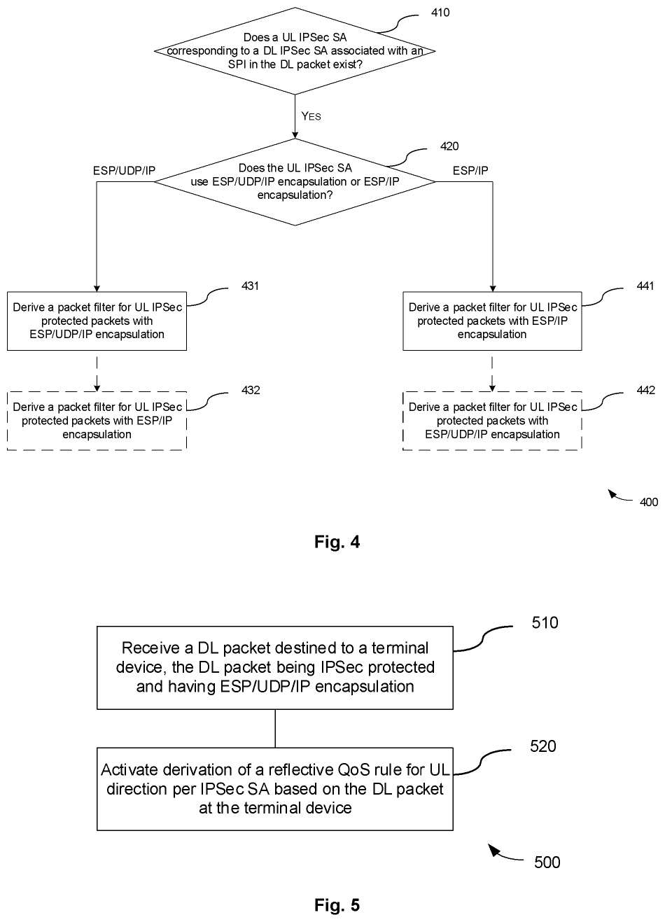

In the following, the block 320 will be further described with reference to FIG. 4, which shows a process 400 for derivation of the packet filter for UL direction.

As shown in FIG. 4, at block 410, it is determined whether a UL IPsec SA corresponding to a DL IPSec SA associated with an SPI in the DL packet exists or not. If not (e.g., in the case of unidirectional communication or when the UL IPsec SA cannot be obtained from an upper layer), the packet filter for UL direction can be derived as containing:
an IP (IPv4 or IPv6) remote address component set to a value of a source address field of the DL packet;
an IP (IPv4 or IPv6) local address component set to a value of a destination address field of the DL packet;
a protocol identifier or next header type component set to a value of a protocol field or the last next header field of the DL packet; and
if the protocol field or the last next header field of the DL packet indicates UDP as specified in the IETF RFC 768:
   a single local port type component set to a value of a destination port field of the received DL packet; and
   a single remote port type component set to a value of a source port field of the received DL packet.

If the UL IPsec SA corresponding to the DL IPSec SA associated with the SPI in the DL packet exists in the block 410, at block 420, it is determined whether the UL IPsec SA uses ESP/UDP/IP encapsulation or ESP/IP encapsulation. If the UL IPsec SA uses ESP/UDP/IP encapsulation, the process proceeds with block 431; or if the UL IPsec SA uses ESP/IP encapsulation, the process proceeds with block 441.

At block 431, a packet filter for UL IPSec protected packets with ESP/UDP/IP encapsulation is derived based on an SPI associated with the UL IPSec SA. The packet filter for UL IPSec protected packets with ESP/UDP/IP encapsulation contains an SPI type component set to the SPI associated with the UL IPSec SA. In addition, the packet filter for UL IPSec protected packets with ESP/UDP/IP encapsulation may further contain:
a single local port type component set to a value of a source port field of the UL IPsec SA (or to a value of a destination port field of the DL packet when the DL packet has ESP/UDP/IP encapsulation), and
a single remote port type component set to a value of a destination port field of the UL IPsec SA (or to a value of a source port field of the DL packet when the DL packet has ESP/UDP/IP encapsulation).

The packet filter for UL IPSec protected packets with ESP/UDP/IP encapsulation may further contain:
an IP (IPv4 or IPv6) remote address component set to a value of a source address field of the DL packet,
an IP (IPv4 or IPv6) local address component set to a value of a destination address field of the DL packet, and
a protocol identifier or next header type component set to a value of UDP (or to a value of a protocol identifier field or the last next header field of the DL packet when the DL packet has ESP/UDP/IP encapsulation).

At block 441, a packet filter for UL IPSec protected packets with ESP/IP encapsulation is derived based on an SPI associated with the UL IPSec SA. The packet filter for UL IPSec protected packets with ESP/IP encapsulation contains an SPI type component set to the SPI associated with the UL IPSec SA. In addition, the packet filter for UL IPSec protected packets with ESP/IP encapsulation may further contain:
an IP (IPv4 or IPv6) remote address component set to a value of a source address field of the DL packet,
an IP(IPv4 or IPv6) local address component set to a value of a destination address field of the DL packet, and
a protocol identifier or next header type component set to a value of ESP (or to a value of a protocol identifier field or the last next header field of the DL packet when the DL packet has ESP/IP encapsulation).

In an example, if the UL IPsec SA uses ESP/UDP/IP encapsulation, in the block 432, a packet filter for UL IPSec protected packets with ESP/IP encapsulation can be derived based the an SPI associated with the UL IPSec SA, in addition to the packet filter for UL IPSec protected packets with ESP/UDP/IP encapsulation as derived in the block 431. Here, the packet filter derived in the block 432 and the packet filter derived in the block 431 may belong to the same reflective QoS rule, or to different reflective QoS rules. For details of the derivation of the packet filter in the block 432, reference can be made to the derivation of the packet filter in the block 441, and description thereof will be omitted here.

In an example, if the UL IPsec SA uses ESP/IP encapsulation, in the block 442, a packet filter for UL IPSec protected packets with ESP/UDP/IP encapsulation can be derived based the an SPI associated with the UL IPSec SA, in addition to the packet filter for UL IPSec protected packets with ESP/IP encapsulation as derived in the block 441. Here, the packet filter derived in the block 442 and the packet filter derived in the block 441 may belong to the same reflective QoS rule, or to different reflective QoS rules. For details of the derivation of the packet filter in the block 442, reference can be made to the derivation of the packet filter in the block 431, and description thereof will be omitted here.

The terminal device may have a number of reflective QoS rules. The terminal device can attempt to associate a UL user data packet with one of the reflective QoS rules as follows.

For a UL packet that is IPSec protected and has ESP/UDP/IP encapsulation, if there are a plurality of reflective QoS rules having IP header components (e.g., source IP address, destination IP address, source port number, destination port number, and protocol identifier/next header) matching IP header components of the UL packet, the terminal device can associate the UL packet with one of the plurality of reflective QoS rules in a descending order of priority as follows. When a reflective QoS rule for UL direction has IP header components matching the IP header components of the UL packet and an SPI component matching an SPI component of the UL packet, the UL packet can be associated with the reflective QoS rule for UL direction. On the other hand, when no reflective QoS rule for UL direction has IP header components matching the IP header components of the UL packet and an SPI component matching the SPI component of the UL packet, the UL packet can be associated with a reflective QoS rule for UL direction that has IP header components matching the IP header components of the UL packet and has no SPI component.

For a UL packet that is Internet Key Exchange (IKE) protected and has ESP/UDP/IP encapsulation, the UL packet can be associated with a reflective QoS rule for UL direction that has IP header components matching IP header components of the UL packet and has no SPI component.

For a UL packet that is neither IPSec protected nor IKE protected, the UL packet can be associated with a reflective QoS rule for UL direction that has IP header components matching IP header components of the UL packet and has no SPI component.

FIG. 5 is a flowchart illustrating a method 500 according to an embodiment of the present disclosure. The method 500 can be performed by a network node, e.g., a network node implementing a UPF.

At block 510, a DL packet destined to a terminal device is received. The DL packet is IPSec protected and has ESP/UDP/IP encapsulation. For example, the DL packet can be an IPv4 packet having a protocol identifier set to UDP, or the DL packet can be IPv6 packet having a last next header set to UDP.

At block 520, derivation of a reflective QoS rule for UL direction per IPSec SA based on the DL packet at the terminal device is activated, e.g., by setting a RQI in the DL packet to 1. Here, the derivation may include derivation of a packet filter based on an SPI associated with a UL IPsec SA corresponding to a DL IPSec SA associated with an SPI in the DL packet. For further details, reference can be made to the method 300 and the process 400 as described above.

In an example, the derivation of the reflective QoS rule may include generating a new reflective QoS rule or updating an existing reflective QoS rule.

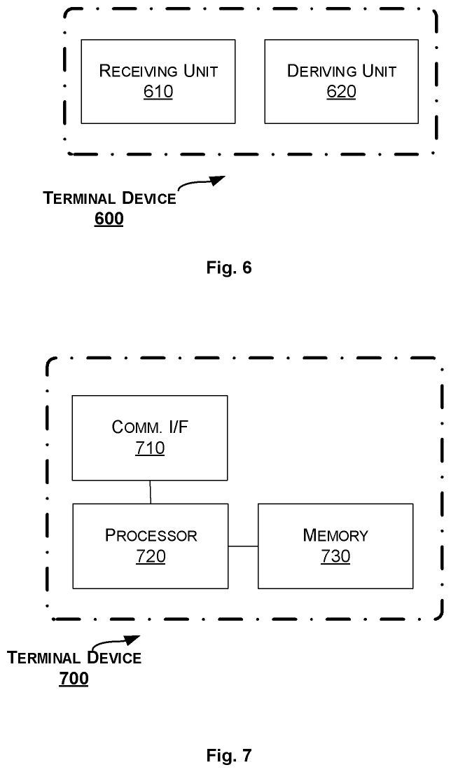

Correspondingly to the method 300 as described above, a terminal device is provided. FIG. 6 is a block diagram of a terminal device 600 according to an embodiment of the present disclosure.

As shown in FIG. 6, the terminal device 600 includes a receiving unit 610 configured to receive a DL packet, the DL packet being IPSec protected. The terminal device 600 further includes a deriving unit 620 configured to derive a reflective QoS rule for UL direction per IPSec SA based on the DL packet.

In an embodiment, the DL packet may have ESP/UDP/IP encapsulation or ESP/IP encapsulation.

In an embodiment, the deriving unit 620 may be configured to: when a UL IPsec SA corresponding to a DL IPSec SA associated with an SPI in the DL packet uses ESP/UDP/IP encapsulation: derive a packet filter for UL IPSec protected packets with ESP/UDP/IP encapsulation based on an SPI associated with the UL IPSec SA.

In an embodiment, the deriving unit 620 may be further configured to derive a packet filter for UL IPSec protected packets with ESP/IP encapsulation based on an SPI associated with the UL IPSec SA.

In an embodiment, the deriving unit 620 may be configured to: when a UL IPsec SA corresponding to a DL IPSec SA associated with an SPI in the DL packet uses ESP/IP encapsulation: derive a packet filter for UL IPSec protected packets with ESP/IP encapsulation based on an SPI associated with the UL IPSec SA.

In an embodiment, the deriving unit 620 may be further configured to derive a packet filter for UL IPSec protected packets with ESP/UDP/IP encapsulation based on an SPI associated with the UL IPSec SA.

In an embodiment, the packet filter for UL IPSec protected packets with ESP/UDP/IP encapsulation may contain an SPI type component set to the SPI associated with the UL IPSec SA.

In an embodiment, the packet filter for UL IPSec protected packets with ESP/UDP/IP encapsulation may further contain: a single local port type component set to a value of a source port field of the UL IPsec SA, and a single remote port type component set to a value of a destination port field of the UL IPsec SA.

In an embodiment, the packet filter for UL IPSec protected packets with ESP/UDP/IP encapsulation may further contain: an IP remote address component set to a value of a source address field of the DL packet, an IP local address component set to a value of a destination address field of the DL packet, and a protocol identifier or next header type component set to a value of UDP.

In an embodiment, when the DL packet has ESP/UDP/IP encapsulation, the packet filter for UL IPSec protected packets with ESP/UDP/IP encapsulation may further contain: a single local port type component set to a value of a destination port field of the DL packet, and a single remote port type component set to a value of a source port field of the DL packet.

In an embodiment, the packet filter for UL IPSec protected packets with ESP/UDP/IP encapsulation may further contain: an IP remote address component set to a value of a source address field of the DL packet, an IP local address component set to a value of a destination address field of the DL packet, and a protocol identifier or next header type component set to a value of a protocol identifier field or a last next header field of the DL packet.

In an embodiment, the packet filter for UL IPSec protected packets with ESP/IP encapsulation may contain an SPI type component set to the SPI associated with the UL IPSec SA.

In an embodiment, the packet filter for UL IPSec protected packets with ESP/IP encapsulation may further contain: an IP remote address component set to a value of a source address field of the DL packet, an IP local address component set to a value of a destination address field of the DL packet, and a protocol identifier or next header type component set to a value of ESP.

In an embodiment, when the DL packet has ESP/IP encapsulation, the packet filter for UL IPSec protected packets with ESP/IP encapsulation may further contain: an IP remote address component set to a value of a source address field of the DL packet, an IP local address component set to a value of a destination address field of the DL packet, and a protocol identifier or next header type component set to a value of a protocol identifier field or a last next header field of the DL packet.

In an embodiment, the DL packet may be an IPv4 packet having a protocol identifier set to UDP or ESP, or the DL packet may be an IPv6 packet having a last next header set to UDP or ESP.

In an embodiment, the DL packet may contain an RQI set to 1.

In an embodiment, the terminal device 600 may further include an associating unit configured to, for a UL packet that is IPSec protected and has ESP/UDP/IP encapsulation: when a reflective QoS rule for UL direction has IP header components matching IP header components of the UL packet and an SPI component matching an SPI component of the UL packet, associate the UL packet with the reflective QoS rule for UL direction, or when no reflective QoS rule for UL direction has IP header components matching the IP header components of the UL packet and an SPI component matching the SPI component of the UL packet, associate the UL packet with a reflective QoS rule for UL direction that has IP header components matching the IP header components of the UL packet and has no SPI component.

In an embodiment, the terminal device 600 may further include an associating unit configured to, for a UL packet that is IKE protected and has ESP/UDP/IP encapsulation: associate the UL packet with a reflective QoS rule for UL direction that has IP header components matching IP header components of the UL packet and has no SPI component.

The units 610 and 620 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 3.

FIG. 7 is a block diagram of a terminal device 700 according to another embodiment of the present disclosure.

The terminal device 700 includes a communication interface 710, a processor 720 and a memory 730. The memory 730 contains instructions executable by the processor 720 whereby the terminal device 700 is operative to perform the actions, e.g., of the procedure described earlier in conjunction with FIG. 3. Particularly, the memory 730 contains instructions executable by the processor 720 whereby the terminal device 700 is operative to: receive a DL packet, the DL packet being IPSec protected; and derive a reflective QoS rule for UL direction per IPSec SA based on the DL packet.

In an embodiment, the DL packet may have ESP/UDP/IP encapsulation or ESP/IP encapsulation.

In an embodiment, the operation of deriving the reflective QoS rule may include: when a UL IPsec SA corresponding to a DL IPSec SA associated with an SPI in the DL packet uses ESP/UDP/IP encapsulation: deriving a packet filter for UL IPSec protected packets with ESP/UDP/IP encapsulation based on an SPI associated with the UL IPSec SA.

In an embodiment, the memory 730 may further contain instructions executable by the processor 720 whereby the terminal device 700 is operative to: derive a packet filter for UL IPSec protected packets with ESP/IP encapsulation based on an SPI associated with the UL IPSec SA.

In an embodiment, the operation of deriving the reflective QoS rule may include, when a UL IPsec SA corresponding to a DL IPSec SA associated with an SPI in the DL packet uses ESP/IP encapsulation: deriving a packet filter for UL IPSec protected packets with ESP/IP encapsulation based on an SPI associated with the UL IPSec SA.

In an embodiment, the memory 730 may further contain instructions executable by the processor 720 whereby the terminal device 700 is operative to: derive a packet filter for UL IPSec protected packets with ESP/UDP/IP encapsulation based on an SPI associated with the UL IPSec SA.

In an embodiment, the packet filter for UL IPSec protected packets with ESP/UDP/IP encapsulation may contain an SPI type component set to the SPI associated with the UL IPSec SA.

In an embodiment, the packet filter for UL IPSec protected packets with ESP/UDP/IP encapsulation may further contain: a single local port type component set to a value of a source port field of the UL IPsec SA, and a single remote port type component set to a value of a destination port field of the UL IPsec SA.

In an embodiment, the packet filter for UL IPSec protected packets with ESP/UDP/IP encapsulation may further contain: an IP remote address component set to a value of a source address field of the DL packet, an IP local address component set to a value of a destination address field of the DL packet, and a protocol identifier or next header type component set to a value of UDP.

In an embodiment, when the DL packet has ESP/UDP/IP encapsulation, the packet filter for UL IPSec protected packets with ESP/UDP/IP encapsulation may further contain: a single local port type component set to a value of a destination port field of the DL packet, and a single remote port type component set to a value of a source port field of the DL packet.

In an embodiment, the packet filter for UL IPSec protected packets with ESP/UDP/IP encapsulation may further contain: an IP remote address component set to a value of a source address field of the DL packet, an IP local address component set to a value of a destination address field of the DL packet, and a protocol identifier or next header type component set to a value of a protocol identifier field or a last next header field of the DL packet.

In an embodiment, the packet filter for UL IPSec protected packets with ESP/IP encapsulation may contain an SPI type component set to the SPI associated with the UL IPSec SA.

In an embodiment, the packet filter for UL IPSec protected packets with ESP/IP encapsulation may further contain: an IP remote address component set to a value of a source address field of the DL packet, an IP local address component set to a value of a destination address field of the DL packet, and a protocol identifier or next header type component set to a value of ESP.

In an embodiment, when the DL packet has ESP/IP encapsulation, the packet filter for UL IPSec protected packets with ESP/IP encapsulation may further contain: an IP remote address component set to a value of a source address field of the DL packet, an IP local address component set to a value of a destination address field of the DL packet, and a protocol identifier or next header type component set to a value of a protocol identifier field or a last next header field of the DL packet.

In an embodiment, the DL packet may be an IPv4 packet having a protocol identifier set to UDP or ESP, or the DL packet may be an IPv6 packet having a last next header set to UDP or ESP.

In an embodiment, the DL packet may contain an RQI set to 1.

In an embodiment, the memory 730 may further contain instructions executable by the processor 720 whereby the terminal device 700 is operative to, for a UL packet that is IPSec protected and has ESP/UDP/IP encapsulation: when a reflective QoS rule for UL direction has IP header components matching IP header components of the UL packet and an SPI component matching an SPI component of the UL packet, associate the UL packet with the reflective QoS rule for UL direction, or when no reflective QoS rule for UL direction has IP header components matching the IP header components of the UL packet and an SPI component matching the SPI component of the UL packet, associate the UL packet with a reflective QoS rule for UL direction that has IP header components matching the IP header components of the UL packet and has no SPI component.

In an embodiment, the memory 730 may further contain instructions executable by the processor 720 whereby the terminal device 700 is operative to, for a UL packet that is IKE protected and has ESP/UDP/IP encapsulation: associate the UL packet with a reflective QoS rule for UL direction that has IP header components matching IP header components of the UL packet and has no SPI component.

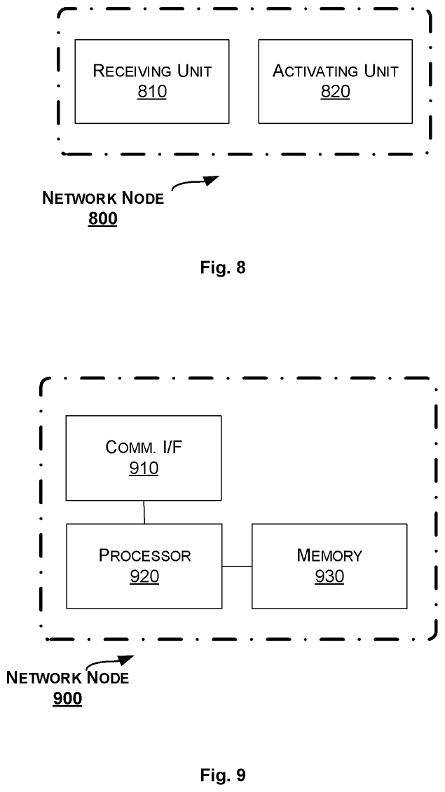

Correspondingly to the method 500 as described above, a network node is provided. FIG. 8 is a block diagram of a network node 800 according to an embodiment of the present disclosure.

As shown in FIG. 8, the network node 800 includes a receiving unit 810 configured to receive a DL packet destined to a terminal device, the DL packet being IPSec protected and having ESP/UDP/IP encapsulation. The network node 800 further includes an activating unit 820 configured to activate derivation of a reflective QoS rule for UL direction per IPSec SA based on the DL packet at the terminal device.

In an embodiment, the DL packet may be an IPv4 packet having a protocol identifier set to UDP, or the DL packet may be an IPv6 packet having a last next header set to UDP.

In an embodiment, the derivation may include derivation of a packet filter based on an SPI associated with a UL IPsec SA corresponding to a DL IPSec SA associated with an SPI in the DL packet.

In an embodiment, the activating unit 820 may be configured to set an RQI in the DL packet to 1.

In an embodiment, the network node may implement a UPF.

FIG. 9 is a block diagram of a network node 900 according to another embodiment of the present disclosure.

The network node 900 includes a communication interface 910, a processor 920 and a memory 930. The memory 930 contains instructions executable by the processor 920 whereby the network node 900 is operative to perform the actions, e.g., of the procedure described earlier in conjunction with FIG. 5. Particularly, the memory 930 contains instructions executable by the processor 920 whereby the network node 900 is operative to: receive a DL packet destined to a terminal device, the DL packet being IPSec protected and having ESP/UDP/IP encapsulation; and activate derivation of a reflective QoS rule for UL direction per IPSec SA based on the DL packet at the terminal device.

In an embodiment, the DL packet may be an IPv4 packet having a protocol identifier set to UDP, or the DL packet may be an IPv6 packet having a last next header set to UDP.

In an embodiment, the derivation may include derivation of a packet filter based on an SPI associated with a UL IPsec SA corresponding to a DL IPSec SA associated with an SPI in the DL packet.

In an embodiment, the operation of activating may include setting an RQI in the DL packet to 1.

In an embodiment, the network node may implement a UPF.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 720 causes the terminal device 700 to perform the actions, e.g., of the procedure described earlier in conjunction with FIG. 3; or code/computer readable instructions, which when executed by the processor 920 causes the network node 900 to perform the actions, e.g., of the procedure described earlier in conjunction with FIG. 5.

The computer program product may be configured as a computer program code structured in computer program modules. The computer program modules could essentially perform the actions of the flow illustrated in FIG. 3 or 5.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method in a terminal device, comprising:
receiving a downlink, DL, packet, the DL packet being Internet Protocol “IP” Security, IPSec, protected; and
deriving a reflective Quality of Service, QoS, rule for uplink, UL, direction per IPSec Security Association, SA, based on the DL packet.

2. The method of claim 1, wherein the DL packet has Encapsulating Security Payload, ESP/User Datagram Protocol, UDP/IP encapsulation or ESP/IP encapsulation.

3. The method of claim 2, wherein said deriving the reflective QoS rule comprises, when a UL IPsec SA corresponding to a DL IPSec SA associated with a Security Parameter Index, SPI, in the DL packet uses ESP/UDP/IP encapsulation:
deriving a packet filter for UL IPSec protected packets with ESP/UDP/IP encapsulation based on an SPI associated with the UL IPSec SA.

4.-6. (canceled)

7. The method of claim 3, wherein the packet filter for UL IPSec protected packets with ESP/UDP/IP encapsulation contains an SPI type component set to the SPI associated with the UL IPSec SA.

8. The method of claim 7, wherein the packet filter for UL IPSec protected packets with ESP/UDP/IP encapsulation further contains:
a single local port type component set to a value of a source port field of the UL IPsec SA, and
a single remote port type component set to a value of a destination port field of the UL IPsec SA.

9. The method of claim 8, wherein the packet filter for UL IPSec protected packets with ESP/UDP/IP encapsulation further contains:
an IP remote address component set to a value of a source address field of the DL packet,
an IP local address component set to a value of a destination address field of the DL packet, and
a protocol identifier or next header type component set to a value of UDP.

10. The method of claim 7, wherein, when the DL packet has ESP/UDP/IP encapsulation, the packet filter for UL IPSec protected packets with ESP/UDP/IP encapsulation further contains:
a single local port type component set to a value of a destination port field of the DL packet, and
a single remote port type component set to a value of a source port field of the DL packet.

11. The method of claim 10, wherein the packet filter for UL IPSec protected packets with ESP/UDP/IP encapsulation further contains:
an IP remote address component set to a value of a source address field of the DL packet,
an IP local address component set to a value of a destination address field of the DL packet, and
a protocol identifier or next header type component set to a value of a protocol identifier field or a last next header field of the DL packet.

12.-14. (canceled)

15. The method of claim 2, wherein
the DL packet is an IP version 4, IPv4, packet having a protocol identifier set to UDP, or
the DL packet is an IP version 6, IPv6, packet having a last next header set to UDP.

16. The method of claim 1, wherein the DL packet contains a Reflective QoS Indicator, RQI, set to 1.

17. The method of claim 3, further comprising, for a UL packet that is IPSec protected and has ESP/UDP/IP encapsulation:
when a reflective QoS rule for UL direction has IP header components matching IP header components of the UL packet and an SPI component matching an SPI component of the UL packet, associating the UL packet with the reflective QoS rule for UL direction, or
when no reflective QoS rule for UL direction has IP header components matching the IP header components of the UL packet and an SPI component matching the SPI component of the UL packet, associating the UL packet with a reflective QoS rule for UL direction that has IP header components matching the IP header components of the UL packet and has no SPI component.

18. The method of claim 1, further comprising, for a UL packet that is Internet Key Exchange, IKE, protected and has ESP/UDP/IP encapsulation:
associating the UL packet with a reflective QoS rule for UL direction that has IP header components matching IP header components of the UL packet and has no SPI component.

19. A terminal device, comprising a communication interface, a processor and a memory, the memory comprising instructions executable by the processor whereby the terminal device is operative to:
receive a downlink, DL, packet, the DL packet being Internet Protocol “IP” Security, IPSec, protected; and
derive a reflective Quality of Service, QoS, rule for uplink, UL, direction per IPSec Security Association, SA, based on the DL packet.

20.-27. (canceled)
